(19) United States
(12) Patent Application Publication
(10) Pub. No.: US 2011/0084132 A1
(43) Pub. Date: Apr. 14, 2011

(54) Devices, Systems and Methods for Secure Remote Medical Diagnostics

(75) Inventor: Mostafa Tofighbakhsh, Cupertino, CA (US)

(73) Assignee: AT&T INTELLECTUAL PROPERTY I, L.P., Reno, NV (US)

(21) Appl. No.: 12/575,624

(22) Filed: Oct. 8, 2009

(51) Int. Cl. G06K 5/00; G06K 19/06

(52) U.S. Cl. 235/380; 235/492; 705/3

(57) ABSTRACT

Devices, systems and methods are disclosed which relate to collecting and distributing medical diagnostics using a smart card. A smart card with secure medical diagnostics logic on the memory is disclosed. When the smart card is inserted into a wireless communications device, the smart card receives data from a wireless medical diagnostic device. The wireless medical diagnostic device can be wearable by a user. The smart card stores the data in a medical diagnostics database on the smart card memory. A doctor or other medical professional may access the data in the medical diagnostics database after providing authentication.

### BACKGROUND OF THE INVENTION

1. Field of the Invention

The present invention relates to the collection and distribution of medical diagnostics. More specifically, the present invention relates to the collection and distribution of medical diagnostics by a smart card.

2. Background of the Invention

Today there are many health statistics that are important to diagnosing the average individual. Besides statistics like pulse and temperature, records indicating vaccinations, allergies, and blood type, which are not only useful in some everyday circumstances, can become crucial in an emergency situation. However, since the enactment of The Health Insurance Portability and Accountability Act (HIPAA), certain precautions must be taken to keep this information between the patient and his or her doctor.

When visiting the doctor people often complain about past conditions or episodes. However, a doctor can only test the patient's current status and ask them questions to recall how they felt during the past episode. Patient recounts can be uninformative and unreliable. Patients largely do not recall things such as instant pulse, blood pressure, temperature, etc. For instance, a patient may remember feeling cold, which can indicate a high temperature, but there is no way for the doctor to determine the exact temperature or even if the patient had a fever at all. If the patient could hand the doctor a complete diagnostic history, then the doctor may not need to examine or ask the patient any questions before coming to a medical conclusion.

Emergency situations can also benefit from a complete diagnostic history of a subject. Emergency personnel deal with unconscious victims and must guess as to the specific injuries or their extent. However, if the emergency personnel were able to see a complete diagnostic history, then some of the guess work may be eliminated.

Information in the form of a complete diagnostic history is not just helpful in an emergency situation, but can have benefits at any time. Specially conditioned people must check their status from time to time. Diabetics must check their blood/sugar level, people with hypertension must check their blood pressure, and some elderly people have a number of things to check on periodically. Current technology can aid people with this burden, but they must take it upon themselves to act on the results.

The current state of the art has wrist monitors for simple medical readings such as pulse, temperature, blood pressure, and blood/sugar. These have been in use by patients of various necessities because of the need for constant monitoring.

GPS units can give a vector, a position and a velocity, for itself, using a satellite system created and maintained by the United States Government. GPS, also known as NAVigation System Timing and Ranging Global Positioning System, or NAVSTAR GPS, has been available for public use since 1996. GPS, when first installed, gave a position accurate up to 15 meters, or 50 feet. Since 2000, a system known as the Wide-Area Augmentation System, or WAAS, has decreased the margin of error to 2 meters, or 6 feet. GPS units have become increasingly popular since their debut. Many new devices come installed with GPS units and some feature navigation systems.

### SUMMARY OF THE INVENTION

The present invention includes devices, systems, and methods for collecting and distributing medical diagnostics using a smart card. Exemplary embodiments of the present invention include a smart card with a secure medical diagnostics logic on the memory. When the smart card is inserted into a wireless communications device, the smart card receives data from a wireless medical diagnostic device. The wireless medical diagnostic device can be wearable by a user. The smart card stores the data in a medical diagnostics database on the smart card memory. A doctor or other medical professional may access the data in the medical diagnostics database after providing authentication.

For example, a user may wear a thermometer which is constantly reading the user's temperature. The thermometer is coupled to a BLUETOOTH transceiver which securely transmits the user's temperature to the user's wireless communications device. The smart card coupled with the wireless communications device stores the temperatures along with the time and date taken into the medical diagnostics database. When the user visits the doctor next, the doctor may input authentication to retrieve a history of the user's temperature. When combined with other medical diagnostics the doctor may not need to test the patient at all before coming to a medical conclusion. Furthermore, the user may not even need to physically visit a doctor. The user may contact a medical office over a network which, in response, requests the user's medical diagnostics from across the network. The medical office inputs authentication and the smart card sends the medical diagnostics to the medical office. The medical office may come to a medical conclusion without the user having to go anywhere.

In one exemplary embodiment, the present invention is a smart card insertable into a wireless communication device for secure remote medical diagnostics. The smart card includes a processor, a memory in communication with the processor, a secure medical diagnostics logic on the memory, a medical diagnostics database on the memory, and a contact area for communication of a coupled wireless communication device with the processor. The secure medical diagnostics logic receives data from a wireless medical diagnostic device in communication with the coupled wireless communication device and securely stores the data in the medical diagnostics database.

In another exemplary embodiment, the present invention is a system for secure remote medical diagnostics. The system includes a wireless communication device, a smart card coupled with the wireless communication device, a secure medical diagnostics logic on a smart card memory, a medical diagnostics database on the smart card memory, and a wireless medical diagnostic device in communication with the wireless communication device. The secure medical diagnostics logic receives data from the wireless medical diagnostic device and securely stores the data in the medical diagnostics database.

In yet another exemplary embodiment, the present invention is a method for secure remote medical diagnostics using a smart card. The method comprises coupling the smart card with a wireless communication device, receiving data from a wireless medical diagnostic device, securely storing the data in a medical diagnostics database on a smart card memory, receiving a request for data in the medical diagnostics database, and sending data in the medical diagnostics database. A logic on the smart card requires authentication before sending data in the medical diagnostics database.

### BRIEF DESCRIPTION OF THE DRAWINGS

FIG. 1 shows a smart card having a secure medical diagnostic logic and a medical diagnostics database, according to an exemplary embodiment of the present invention.

FIG. 2 shows a smart card coupled with a wireless communications device in communication with a plurality of wireless medical diagnostic devices, according to an exemplary embodiment of the present invention.

FIG. 3A shows a wireless communications device having a smart card, according to an exemplary embodiment of the present invention.

FIG. 3B shows the components of a wireless communications device having a smart card, according to an exemplary embodiment of the present invention.

FIG. 4 shows a flowchart for a method of collecting and distributing medical diagnostics, according to an exemplary embodiment of the present invention.

FIG. 5 shows an application for collecting medical diagnostics on a wireless communications device, according to an exemplary embodiment of the present invention.

FIG. 6 shows a system for distributing medical diagnostics over a network, according to an exemplary embodiment of the present invention.

FIG. 7 shows a system for distributing medical diagnostics directly from a smart card, according to an exemplary embodiment of the present invention.

### DETAILED DESCRIPTION OF THE INVENTION

The present invention includes devices, systems, and methods for collecting and distributing medical diagnostics using a smart card. Exemplary embodiments of the present invention include a smart card with a secure medical diagnostics logic on the memory. When the smart card is inserted into a wireless communications device, the smart card receives data from a wireless medical diagnostic device. The wireless medical diagnostic device can be wearable by a user. The smart card stores the data in a medical diagnostics database on the smart card memory. A doctor or other medical professional may access the data in the medical diagnostics database after providing authentication.

For example, a user may wear a thermometer which is constantly reading the user's temperature. The thermometer is coupled to a BLUETOOTH transceiver which securely transmits the user's temperature to the user's wireless communications device. The smart card coupled with the wireless communications device stores the temperatures along with the time and date taken into the medical diagnostics database. When the user visits the doctor, the doctor may input an authentication code to retrieve a history of the user's temperature. When combined with other medical diagnostics the doctor may not need to test the patient at all before coming to a medical conclusion. Furthermore, the user may not even need to physically visit a doctor. The user can contact a medical office over a network which, in response, requests the user's medical diagnostics from across the network. The medical office inputs an authentication code and the smart card sends the medical diagnostics to the medical office. The medical office may come to a medical conclusion without the user having to travel.

“Smart card”, as used herein and throughout this disclosure, refers to a card with integrated circuits and including a memory and a processor and may be read by an electronic device. Smart cards are similar to memory cards in that they have a memory and can be read by electronic devices. However, smart cards differ in that they include a processor. Smart cards are often equipped with logic to require authentication before revealing the contents of its memory. Examples of smart cards include Integrated Circuit Cards (ICC), Universal ICCs (UICC), Subscriber Identity Module (SIM) cards, etc., and combinations thereof.

“Wireless communications device”, as used herein and throughout this disclosure, refers to any device capable of wirelessly sending and receiving data. Examples of a handheld communications device include cellular telephones, personal digital assistants (PDAs), laptop computers, portable music devices having wireless technology, etc.

“Logic”, as used herein and throughout this disclosure, refers to any information having the form of instruction signals and/or data that may be applied to affect the operation of a processor. Examples of processors are computer processors (processing units), microprocessors, digital signal processors, controllers and microcontrollers, etc. Logic may be formed from signals stored in a device memory. Software is one example of such logic. Examples of device memories that may comprise logic include RAM (random access memory), flash memories, ROMS (read-only memories), EPROMS (erasable programmable read-only memories), and EEPROMS (electrically erasable programmable read-only memories). Logic may also be comprised by digital and/or analog hardware circuits, for example, hardware circuits comprising logical AND, OR, XOR, NAND, NOR, and other logical operations. Logic may be formed from combinations of software and hardware.

For the following description, it can be assumed that most correspondingly labeled structures across the figures (e.g., 132 and 232, etc.) possess the same characteristics and are subject to the same structure and function. If there is a difference between correspondingly labeled elements that is not pointed out, and this difference results in a non-corresponding structure or function of an element for a particular embodiment, then that conflicting description given for that particular embodiment shall govern.

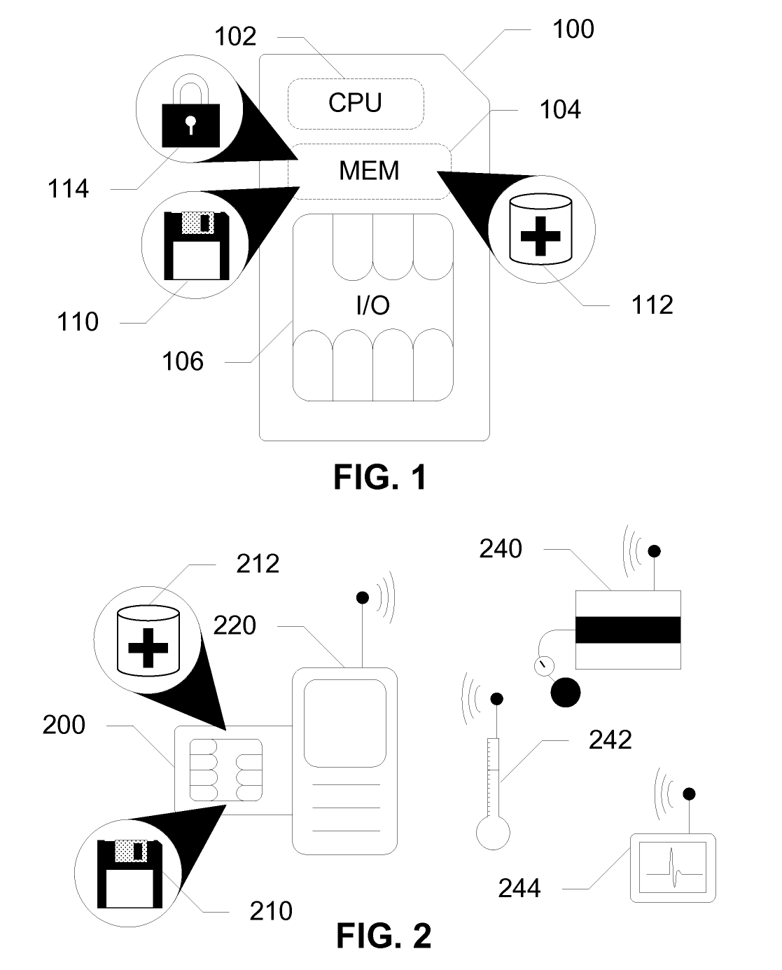

FIG. 1 shows a smart card 100 having a secure medical diagnostic logic 110 and a medical diagnostics database 112, according to an exemplary embodiment of the present invention. Smart card 100 includes a processor 102, a memory 104, and a contact area 106. Processor 102 receives input from and commands the other components of the smart card. Memory 104 stores secure medical diagnostic logic 110 which collects medical data from a wireless medical diagnostic device and stores the medical data in medical diagnostics database 112. Medical diagnostics database 112 is stored in memory 104 as well as security logic 114. Security logic 114 requires authentication before smart card 100 reveals the contents of medical diagnostics database 112. Contact area 106 serves as the communication port between smart card 100 and a Card Accepting Device (CAD). When coupled with a wireless communication device, a wireless transceiver included in the wireless communications device is operable in part by smart card 100. Secure medical diagnostics logic 110 operates the wireless transceiver to receive medical data from the wireless medical diagnostic device.

There is a single memory on this exemplary embodiment of the smart card. However, more than one memory may be used. A Read Only Memory (ROM) can be used to store the secure medical diagnostics logic and the security logic because these programs do not need modification. A Random Access Memory (RAM) must be used to store the medical diagnostics database because medical data is constantly being added to the medical diagnostics database. The secure medical diagnostics logic and the security logic may also be stored on a RAM to permit modifications and upgrades, but security concerns may require the security logic to remain on a ROM. The security logic uses a mutual active authentication protocol where the smart card and an authentication logic of a CAD encrypt random numbers and compare the results in this exemplary embodiment. Other forms of authentication and/or encryption are used in other embodiments and will be recognizable by those having skill in the art. The contact area is a collection of about eight contacts points of copper and gold plated in preferred embodiments. Each contact point is adapted to receive a different signal. Some contact points serve as the main power and ground while others serve as data input and output or application specific signal receivers. The contact points can be arranged differently but in many embodiments follow a standard such as International Organization for Standardization (ISO) 7816-1, 2, 3.

FIG. 2 shows a smart card 200 coupled with a wireless communications device 220 in communication with a plurality of wireless medical diagnostic devices, according to an exemplary embodiment of the present invention. Smart card 200 includes secure medical diagnostics logic 210 and medical diagnostic database 212 on the smart card memory. While smart card 200 is coupled with wireless communications device 220, secure medical diagnostics logic 210 receives medical data from the wireless medical diagnostic devices. The wireless medical diagnostic devices in this embodiment include wireless thermometer 242, wireless blood pressure monitor 240, and wireless pulse monitor 244. Wireless thermometer 242 reads a user's temperature on a periodic basis. After each temperature reading, wireless thermometer 242 transmits the temperature and the time securely to wireless communications device 220. Secure medical diagnostics logic 210 on the smart card memory receives the temperature and time and records them to medical diagnostics database 212. Wireless blood pressure monitor 240 reads a user's blood pressure on a periodic basis. After each blood pressure reading, wireless blood pressure monitor 240 transmits the blood pressure and the time securely to wireless communications device 220. Secure medical diagnostics logic 210 on the smart card memory receives the blood pressure and time and records them to the medical diagnostics database 212. Wireless pulse monitor 244 reads a user's pulse on a periodic basis. After each pulse reading, wireless pulse monitor 240 transmits the pulse and the time securely to wireless communications device 220. Secure medical diagnostics logic 210 on the smart card memory receives the pulse and time and records them to the medical diagnostics database 212. Consequently, a user having smart card 200 coupled with wireless communications device 220 and wearing wireless medical diagnostic devices 240, 242, and 244 keeps a running history of the user's temperature, blood pressure, and pulse. When the user desires a checkup or a diagnosis of a suspected ailment, a doctor can review medical diagnostic database 212 for a complete history of the user's temperature, blood pressure, and pulse to determine the source of the ailment.

Wireless communications device 220 communicates with wireless medical diagnostic devices 240, 242, and 244 using Near Field Communication (NFC) in this exemplary embodiment. BLUETOOTH, WiFi, infrared, Zigbee, etc., are all forms of NFC that are used in embodiments of the present invention. Other forms of wireless communication such as cellular RF, satellite, etc., can be used but require more power consumption, and are therefore less efficient. The medical diagnostic devices are preferably small and unnoticeable so a user may discreetly wear them on a continuing basis. There are many different medical diagnostic devices that read medical data from the user. Wireless blood/sugar monitors can be worn by diabetic users. Wireless respiratory monitors can be worn by asthma patients and other users having respiratory problems. Many other wireless medical diagnostic devices can be made by coupling a medical diagnostic device with a wireless transceiver. Many of these will become recognizable to those having skill in the art when reading this disclosure. Therefore, it will also be apparent to one skilled in the art that besides temperature, blood pressure, and pulse, medical data also includes blood sugar, blood oxygen levels, and other vital statistics that are commonly monitored, externally and internally. Medical data also includes dates, times, and other environmental conditions that can be correlated with the vital statistics being measured.

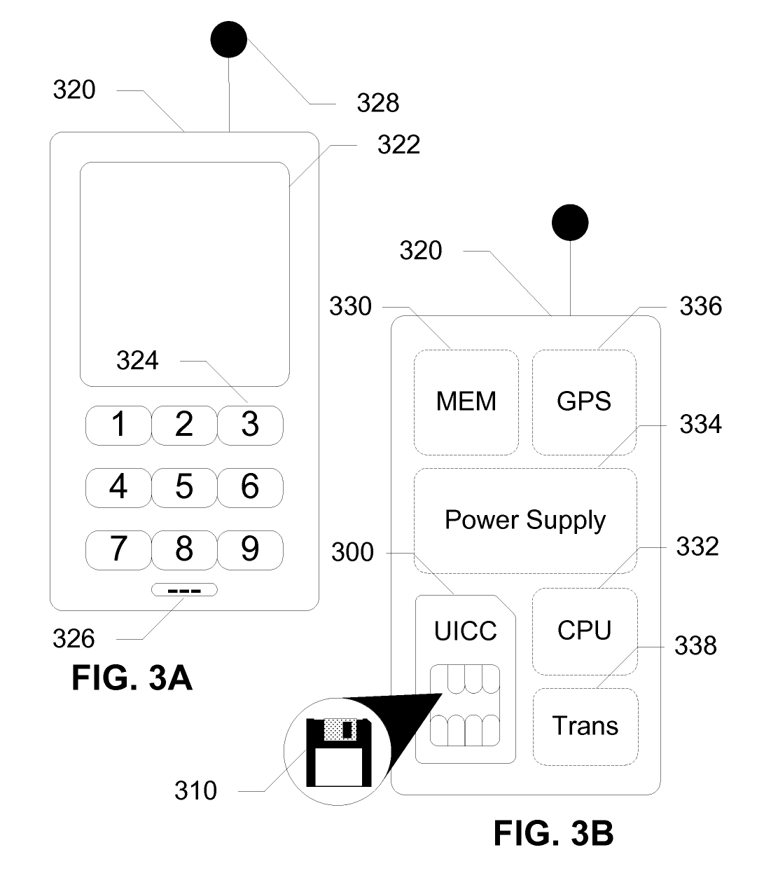

FIGS. 3A and 3B show a wireless communications device 320 having a smart card 300, according to an exemplary embodiment of the present invention. Referring to FIG. 3A, wireless communications device 320 includes common components of a cellular telephone such as display 322, keypad 324, microphone 326, and antenna 328. Display 322 is a Liquid Crystal Display (LCD) that serves as the visual output for the wireless communications device. Keypad 324 is a numerical keypad that serves as the physical input for user commands. The vast majority of the functions of wireless communications device 320 involve user input through keypad 324 and visual output through display 322. Microphone 326 serves as audio input for receiving a user's voice for transmission across a network during a telephone call. Antenna 328 is the transmission and reception point for wireless communication of wireless communication device 320.

In alternate embodiments, the display is a Light Emitting Diode (LED) screen. In further embodiments, the display is a touch-screen which may serve not only as visual output, but is capable of receiving physical input. In embodiments with a touch-screen as the display, a separate keypad as input may not be necessary.

FIG. 3B shows the internal components of a wireless communications device 320 having a smart card 300, according to an exemplary embodiment of the present invention. The components of wireless communications device 320 include a device memory 330, a device processor 332, a power supply 334, a Global Positioning System (GPS) module 336, and a wireless transceiver 338. Device memory 330 stores an operating system and other logic for using wireless communications device 320. Device memory 330 is in communication with device processor 332. Device processor 332 receives and routes data to and from the components of wireless communications device 320. Power supply 334 supplies electrical power to the components of wireless communications device 320 and also smart card 300 when it is coupled with wireless communications device 320. GPS module 336 is in communication with device processor 332 and communicates with satellites to determine the position of wireless communications device 320 anywhere on earth. Wireless transceiver 338 is in communication with device processor 332 and is responsible for communication with networks and other electronic devices. Smart card 300 is coupled with wireless communications device 320 allowing secure medical diagnostics logic 310 to operate components of wireless communications device 320.

For simplicity, only one wireless transceiver is shown, but many alternate embodiments contain multiple wireless transceivers to cover a range of wireless protocols and standards. Though the GPS module is not necessary for the collection and distribution of medical data, it may nevertheless aid a doctor or other medical professional in diagnosing a user. For instance, a doctor may notice that a user's shortness of breath experiences occurred while the user was at the peaks of mountains. The medical data recorded would include the user's pulse, blood/oxygen levels, and the user's location/elevation. Using this data, the doctor can consider the effects of elevation on the respiratory system when diagnosing this user.

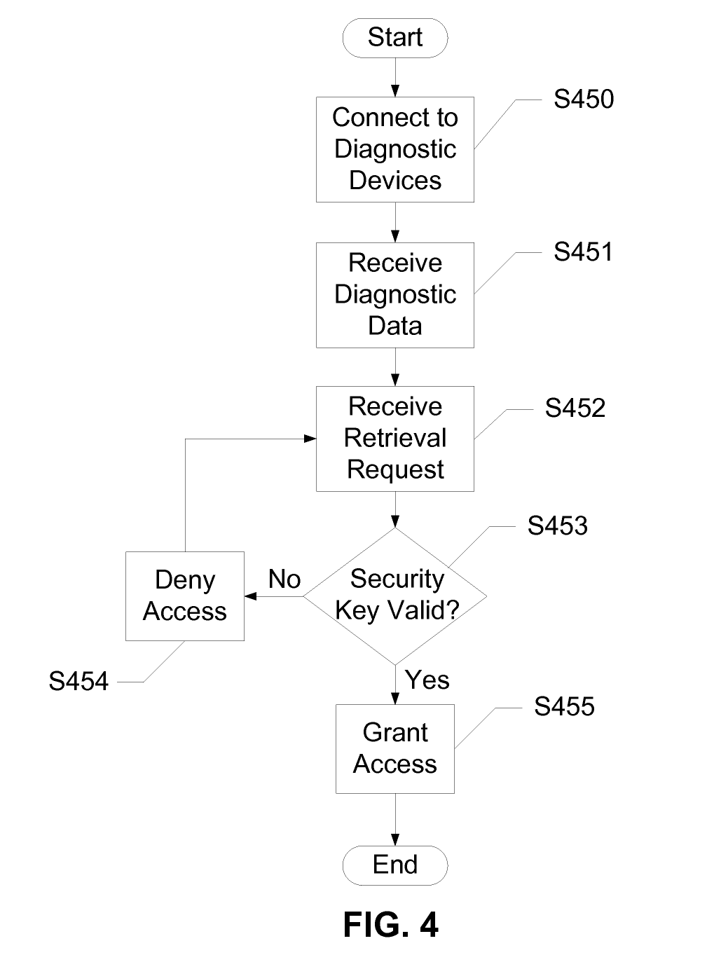

FIG. 4 shows a method for collecting and distributing medical diagnostics, according to an exemplary embodiment of the present invention. Once a smart card having a secure medical diagnostics logic is coupled with a wireless communications device, one or more medical diagnostic devices are wirelessly connected to the wireless communications device S450. For instance, using a BLUETOOTH protocol, these devices can be considered “paired”. Once the devices are connected, the wireless medical diagnostic device begins transmitting medical data on a periodic basis. The secure medical diagnostics logic receives the medical data and records each reading along with the time of the reading to the medical diagnostic database on the smart card memory 451. The medical data remains in the medical diagnostic database until memory on the smart card is needed. Once the smart card memory is full, the earliest medical data can be deleted in favor of the latest medical data. When the user seeks diagnosis a doctor or other medical professional may request access to the medical diagnostic database S452. This request is in an electronic format and is performed by a Card Accepting Device (CAD) employed by the doctor. The smart card is physically removed from the wireless communications device and inserted into the doctor's CAD. The CAD must input a correct security key for the smart card to authorize access to the medical diagnostics database S453. If the CAD inputs an invalid security key, then access is denied S454. If the CAD inputs a valid security key, then access is granted S455, and the doctor may read the contents of the medical diagnostic database.

In embodiments where the wireless communications device includes a GPS module a location of a reading is recorded to the medical diagnostic database along with the reading and the time of the reading. In alternate embodiments the smart card does not need to be removed from the wireless communications device in order to be read by a doctor. A doctor may have a server in wireless communication with the user's wireless communications device that can request access to the medical diagnostic database through the wireless connection. In further embodiments the doctor's server is located across an ultra-wide area network such as a cellular network. In embodiments where a CAD is employed to read the contents of the medical diagnostic database, the security logic may require authentication before access is granted to any area of the smart card. However, additional security measures may be necessary for access across a wireless network, such as to comply with HIPAA. A limit may be imposed on the number of times an invalid key can be entered before the security logic locks the smart card. Once the smart card is locked all access to the smart card is denied. An unlock code must be entered to restore access to the smart card in embodiments with this limit imposed.

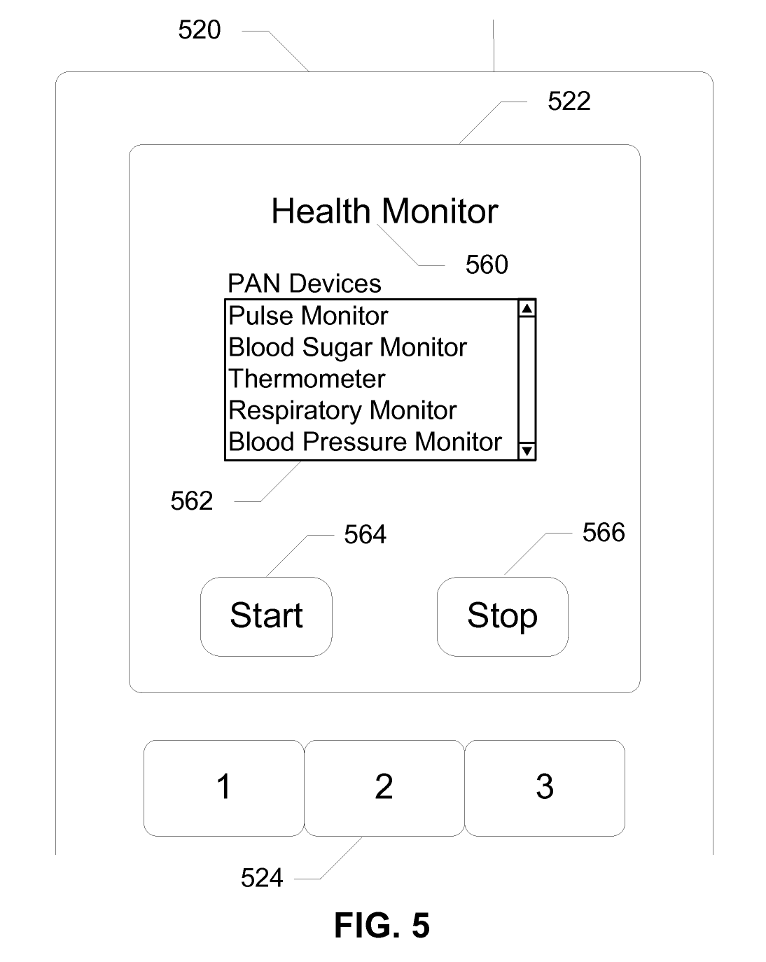

FIG. 5 shows an application 560 for collecting medical diagnostics on a wireless communications device, according to an exemplary embodiment of the present invention. Application 560 includes a Graphical User Interface (GUI) on display 522 where a user views and controls the medical diagnostic devices. Application 560 includes a list 562 of wireless medical diagnostic devices in communication with the wireless communications device. Here the user's wireless communications device is in communication with a pulse monitor, a blood/sugar monitor, a thermometer, a respiratory monitor, and a blood pressure monitor. The user starts the collection process by selecting the “Start” button using a keypad 524. Once the “Start” button has been entered, the medical diagnostic devices deliver medical data to wireless communications device 520. The collection process continues until the user enters the “Stop” button 566 using keypad 524.

In embodiments where the display is a touch-screen, a user can enter the “Start” and “Stop” buttons by touching the respective area of the display. Other embodiments of the application include other options such as location tracking. In wireless communication devices having GPS modules, tracking the location along with the time of each reading can be an option initiated by the user through the application.

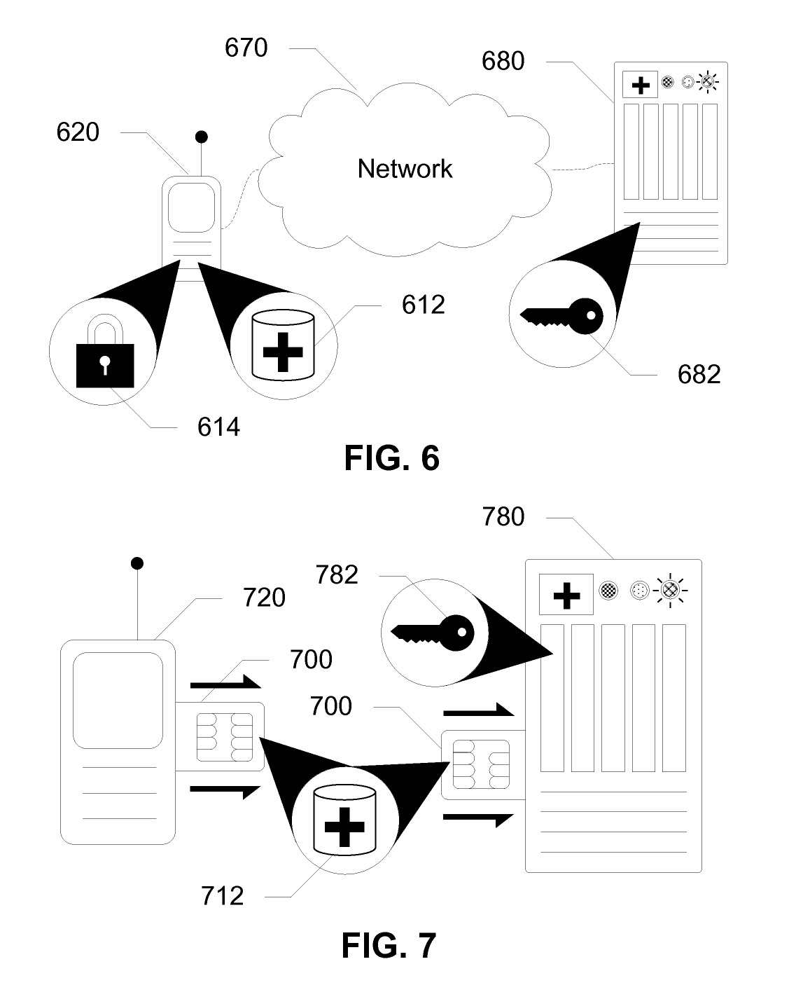

FIG. 6 shows a system for distributing medical diagnostics over a network, according to an exemplary embodiment of the present invention. The system includes a wireless communications device 620 and a server 680 connected to a network 670. Wireless communications device includes a smart card with a medical diagnostics database 612 and a security logic 614.Server 680 includes an authentication logic 682. When a user requests a remote diagnosis, a doctor or medical professional uses server 680 to connect to wireless communications device 620. Once connected, server 680 requests access to medical diagnostics database 612. Wireless communications device 620 requires authentication before granting access. Server 680 uses authentication logic 682 to transmit an authentication code to wireless communications device 620. Security logic 614 receives and verifies the authentication code to allow access to the medical diagnostics database. Once access is granted, server 680 retrieves the contents of medical diagnostics database 612. Once retrieved, the doctor views the contents of medical diagnostics database 612 and makes a diagnosis.

The server is any device that is capable of connecting to a network. Though the wireless communications device is wireless, the server does not need to be wireless. The server must merely connect to the network in some form. The network may be a small area network, where the wireless communications device must be near the server, or an ultra-wide area network, where the wireless communications device can be miles away from the server. Different networks have different connection capabilities and ranges. Those having skill in the art will recognize many suitable network forms. The authentication logic within the server may simply supply an authentication code, use an encryption algorithm, etc. The form of the authentication depends on the security measures of the secure medical diagnostics logic. Those having skill in the art will also recognize many digital security methods.

FIG. 7 shows a system for distributing medical diagnostics directly from a smart card, according to an exemplary embodiment of the present invention. The system comprises a wireless communications device 720 having a smart card 700 with a medical diagnostics database 712 and a CAD 780 having an authentication logic 782. When a user requests a remote diagnosis, the user removes smart card 700 from wireless communications device 720. Smart card 700 is then inserted into CAD 780. Once inserted, CAD 780 requests access to medical diagnostics database 712. Smart card 700 requires authentication before granting access. CAD 780 uses authentication logic 782 to gain access to the medical diagnostics database. Once access is granted, CAD 780 reads the contents of medical diagnostics database 712. Once read, the doctor views the contents of medical diagnostics database 712 and makes a diagnosis.

The CAD is any device that is capable of reading a smart card. The authentication logic within the server may simply supply a authentication code, use an encryption algorithm, etc. The form of the authentication depends on the security measures of the secure logic on the smart card. Those having skill in the art will recognize many digital security methods.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A smart card insertable into a wireless communication device for secure remote medical diagnostics, the smart card comprising:
a processor;
a memory in communication with the processor;
a secure medical diagnostics logic on the memory;
a medical diagnostics database on the memory; and
a contact area for communication between the processor and a coupled wireless communication device;
wherein the secure medical diagnostics logic receives data from a wireless medical diagnostic device in communication with the coupled wireless communication device and securely stores the received data in the medical diagnostics database.

2. The smart card in claim 1, wherein the wireless medical diagnostic device is attachable to a user.

3. The smart card in claim 1, wherein the coupled wireless communication device communicates with the wireless medical diagnostic device using near field communication (NFC).

4. The smart card in claim 3, wherein the NFC is one of BLUETOOTH, infrared, Zigbee and WiFi.

5. The smart card in claim 1, wherein the coupled wireless communication device is a cellular telephone or any WAN connected device including devices connected via WiFi, whitespace, and 4G technologies.

6. The smart card in claim 1, further comprising a security logic for authenticating access to the medical diagnostics database.

7. A system for secure remote medical diagnostics comprising:
a wireless communication device;
a smart card coupled to the wireless communication device, the smart card having a smart card memory;
a secure medical diagnostics logic on the smart card memory;
a medical diagnostics database on the smart card memory; and
a wireless wearable and/or body attached medical sensor device in communication with the wireless communication device;
wherein the secure medical diagnostics logic receives data from the wireless medical sensor device and securely stores the data in the medical diagnostics database.

8. The system in claim 7, wherein the wireless medical sensor device is attachable to a user.

9. The system in claim 7, wherein the wireless communication device communicates with the wireless medical sensor device using near field communication (NFC).

10. The system in claim 9, wherein the NFC is one of BLUETOOTH, infrared, and WiFi or Zigbee.

11. The system in claim 7, wherein the wireless communication device is a cellular telephone.

12. The system in claim 7, wherein the smart card is a Universal Integrated Circuit Card (UICC).

13. A method for secure remote medical diagnostics using a smart card comprising:
coupling the smart card with a wireless communication device;
receiving data from a wireless medical diagnostic device;
securely storing the data in a medical diagnostics database on a smart card memory;
receiving a request for data in the medical diagnostics database; and
sending data in the medical diagnostics database;
wherein a logic on the smart card requires authentication before sending data in the medical diagnostics database.

14. The method in claim 13, further comprising decoupling the smart card with a wireless communication device.

15. The method in claim 13, wherein the receiving further comprises receiving a request for data over a network.

16. The method in claim 13, wherein the receiving further comprises receiving a request for data from a CAD coupled to the smart card.

17. The method in claim 13, wherein the securely storing further comprises encrypting the data.
